(19) United States
(12) Patent Application Publication
(10) Pub. No.: US 2017/0372697 A1
(43) Pub. Date: Dec. 28, 2017

(54) SYSTEMS AND METHODS FOR RULE-BASED USER CONTROL OF AUDIO RENDERING

(71) Applicant: Elwha LLC, Bellevue, WA (US)

(72) Inventors: Jesse R. Cheatham, III, Seattle, WA (US); Roderick A. Hyde, Redmond, WA (US); Muriel Y. Ishikawa, Livermore, CA (US); Jordin T. Kare, San Jose, CA (US); Craig J. Mundie, Seattle, WA (US); Nathan P. Myhrvold, Bellevue, WA (US); Robert C. Petroski, Seattle, WA (US); Eric D. Rudder, Mercer Island, WA (US); Desney S. Tan, Kirkland, WA (US); Clarence T. Tegreene, Mercer Island, WA (US); Charles Whitmer, North Bend, WA (US); Andrew Wilson, Seattle, WA (US); Jeannette M. Wing, Bellevue, WA (US); Lowell L. Wood,, JR., Bellevue, WA (US); Victoria Y.H. Wood, Livermore, CA (US)

(21) Appl. No.: 15/189,969

(22) Filed: Jun. 22, 2016

(51) Int. Cl. G10L 15/22; G10L 25/39; G10L 15/08; G10L 25/84; G10L 25/33

(52) U.S. Cl. CPC G10L 15/22; G10L 25/84; G10L 25/33; G10L 15/08; G10L 25/39; G10L 2015/088; G10L 2015/223

(57) ABSTRACT

A sound processing system includes a sound input device for providing a sound input, a sound output device for providing a sound output, and processing electronics including a processor and a memory, wherein the processing electronics is configured to receive a target sound input identifying a target sound, receive a rule input establishing a sound processing rule that references the target sound, receive a sound input from the sound input device, analyze the sound input for the target sound, process the sound input according to the sound processing rule in view of the analysis of the sound input, and provide a processed sound output to the sound output device.

### BACKGROUND

The present invention relates generally to the fields of sound processing and audio signal processing.

### SUMMARY

One embodiment of the invention relates to a sound processing controller including processing electronics including a processor and a memory, wherein the processing electronics is configured to receive a target sound input identifying a target sound, receive a rule input establishing a sound processing rule that references the target sound, receive a sound input, analyze the sound input for the target sound, process the sound input according to the sound processing rule in view of the analysis of the sound input, and provide a processed sound output.

Another embodiment of the invention relates to a sound processing system including a sound input device for providing a sound input, a sound output device for providing a sound output, and processing electronics including a processor and a memory, wherein the processing electronics is configured to receive a target sound input identifying a target sound, receive a rule input establishing a sound processing rule that references the target sound, receive a sound input from the sound input device, analyze the sound input for the target sound, process the sound input according to the sound processing rule in view of the analysis of the sound input, and provide a processed sound output to the sound output device.

Another embodiment of the invention relates to a media device including processing electronics including a processor and a memory, wherein the processing electronics is configured to receive a target sound input identifying a target sound, receive a rule input establishing a sound processing rule that references the target sound, receive a sound input from the sound input device, analyze the sound input for the target sound, process the sound input according to the sound processing rule in view of the analysis of the sound input, and provide a processed sound output to the sound output device.

Another embodiment of the invention relates to a method of processing a sound input including the steps of establishing a sound processing rule for execution by processing electronics, receiving a sound input with the processing electronics, analyzing the sound input with the processing electronics, processing the sound input with the processing electronics according to the sound processing rule, and providing a processed sound output with the processing electronics.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a schematic representation of a system for providing for rule-based user control of audio rendering according to an exemplary embodiment.

FIG. 2 is a block diagram of the sound processing controller of FIG. 1.

FIG. 3 is a flow chart of a process for rule-based user control of audio rendering according to an exemplary embodiment.

FIG. 4 is a flow chart of a process for establishing a sound processing rule according to an exemplary embodiment.

FIG. 5 is a schematic representation of a graphical user interface for providing for rule-based user control of audio rendering according to an exemplary embodiment.

FIG. 6 is a schematic representation of a graphical user interface for providing for rule-based user control of audio rendering according to an exemplary embodiment.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

Rule-based user control of audio rendering as described herein allows for processing a sound input according to one or more sound processing rules and providing a processed sound output. For example, rule-based user control of audio rendering allows the user to identify one or more target sounds (e.g., where the target sound is a specific type, location, or source of sound or specific targeted content like a name, place, keyword, phrase, or conversation) and process a sound input (e.g., increase volume, decrease volume, mute, etc.) according to one or more sound processing rules referencing the target sound (e.g., logical rules (Boolean logic, fuzzy logic, etc.), mathematical rules, algorithmic rules, etc.) to provide a processed sound output.

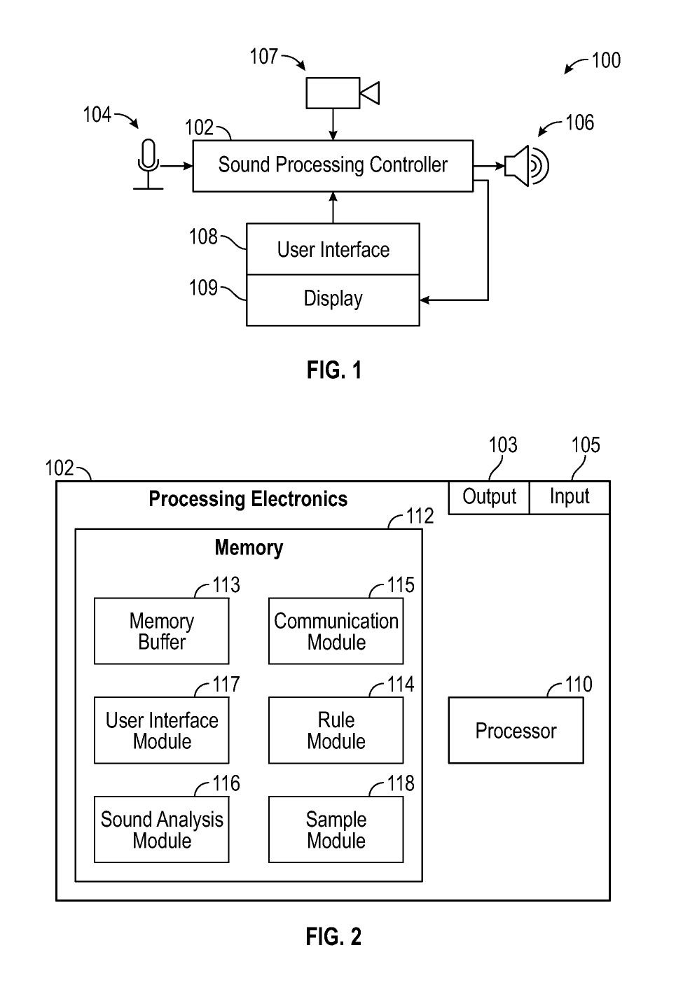

Referring to FIG. 1, a system for providing rule-based user control of audio rendering is illustrated according to an exemplary embodiment. System 100 includes sound processing controller 102 that receives a sound input and processes the sound input according to one or more sound processing rules to provide a processed sound output. Sound inputs and outputs include one or more analog or digital signals representing audio information. The audio information can include one or more voices, instruments, background noise or sounds, animal sounds, weather sounds, etc. The sound input may be a continuous stream of audio information that is sampled by the sound processing control 102 at an appropriate sampling rate (e.g., 1 kHz or more). The samples of the sound input can then be analyzed and processed. Similarly the sound output is presented as a continuous stream of audio information.

The sound input may come from a variety of sources. In some embodiments the sound input is provided by a media device. Media devices include smartphones, mobile devices, and other handheld devices, computers, televisions, video game systems, set-top boxes or set-top units, telephones, video conference devices, and other devices used to play audio media or audio-visual media. In some embodiments, the sound input is a multichannel sound input. The multichannel sound input may include multiple tracks (e.g., individual voice actors, instruments, sound effects, etc.) that have been mixed into a smaller number of channels (e.g., two channel stereo sound, multichannel surround sound, etc.) or the multichannel sound input may have an individual channel for each individual track (e.g., individual voice actors, instruments, sound effects, etc.). In some embodiments, the sound input may include metadata identifying one or more preferred mixes of the various channels (e.g., preferred by the content provider, preferred by an individual user, etc.). The metadata could include digital rights management to limit how the end user is able to process the sound input via the rules-based user controls. In some embodiments, the sound input is acquired from the ambient environment, for example from one or more microphones 104. Directional microphones may also be used to detect sounds emanating from particular locations.

The processed sound output may directly or indirectly drive one or more speakers 106. Speakers 106 may be distinct devices or components of a larger device (e.g., televisions or other display devices, headphones, smartphones, mobile devices, and other handheld devices, telephones, video conference devices, etc.).

In some embodiments, system 100 includes a camera 107 (e.g., a video camera or a still camera) that may be used to identify a target sound by identifying the source of a target sound. For example, camera 107 in combination with a facial-recognition module or other appropriate programming may be used to designate a particular person as the source of the target sound. Camera 107 may be movable to track the speaker.

The user interacts with sound processing controller 102 through one or more user interfaces 108. In some embodiments, user interface 108 includes a graphical user interface (GUI) displayed to a user on a display 109. Suitable displays may include a display of a mobile device or other handheld device, a computer monitor, a television, a display in a remote control, a display in a videogame controller, etc. User interface 108 allows the user to provide inputs to sound processing controller 102, including inputs to identify one or more target sounds, select one or more sound processing rules, and to establish one or parameters, rules, or relationships for the sound processing rules. User inputs may be provided via touch screen, keyboard, mouse or other pointing device, virtual or real sliders, buttons, switches, etc., or other appropriate user interface devices. In some embodiments, user interface 108 appears as virtual mixing board or graphic equalizer that allows the user to identify one or more target sounds and vary or select parameters for one or more sound processing rules. The user inputs or results of the user inputs may be displayed to user on display 109. In some embodiments, display 109 is a component of user interface 108 (e.g., a touchscreen, a remote control including input buttons and a display, etc.). In other embodiments, display 109 is separate from user interface 108 (e.g., a television or set-top box and a remote control, a video game system and a video game controller, etc.).

Referring to FIG. 2, a detailed block diagram of the processing electronics of sound processing controller 102 is shown, according to exemplary embodiment. Sound processing controller 102 includes processing electronics having a processor 110 and a memory 112. Processor 110 may be or include one or more microprocessors, an application specific integrated circuit (ASIC), a circuit containing one or more processing components, a group of distributed processing components, circuitry for supporting a microprocessor, or other hardware configured for processing. According to an exemplary embodiment, processor 110 is configured to execute computer code stored in memory 112 to complete and facilitate the activities described herein. Memory 112 can be any volatile or non-volatile memory device capable of storing data or computer code relating to the activities described herein. For example, memory 112 is shown to include modules 113-118 which are computer code modules (e.g., executable code, object code, source code, script code, machine code, etc.) configured for execution by processor 110. When executed by processor 110, the processing electronics is configured to complete the activities described herein. Processing electronics includes hardware circuitry for supporting the execution of the computer code of modules 113-118. For example, sound processing controller 102 includes hardware interfaces (e.g., output 103) for communicating signals (e.g., analog, digital) from processing electronics to one or more circuits or devices coupled to sound processing controller 102. Sound processing controller 102 may also include an input 105 for receiving data or signals (e.g., analog, digital) from other systems or devices. In some embodiments, sound processing controller 102 may include or be coupled to one or more converters. For example, an analog-to-digital converter (ADC) may be used to convert the sound input signal from analog to digital and a digital-to-analog converter (DAC) may be used to convert the processed sound output signal from digital to analog.

Memory 112 is shown to include a memory buffer 113 for receiving and storing data, for example user input, sound input, downloaded data, etc., until it is accessed by another module or process. Memory 112 is further shown to include a communication module 115, which may include logic for communicating between systems and devices. For example, the communication module 115 may be configured to use an antenna or data port for communication over a network. The communication module 115 may further be configured to communicate with other components a parallel bus, serial bus, or network. Memory 112 is further shown to include a user interface module 117, which includes logic for using user input data in memory buffer 113 or signals from input 105 to determine desired responses. For example, the user interface module 117 may be configured to convert, transform, or process signals or data from user interface 108 (e.g., a keyboard, mouse, or touchscreen) into signals or data useable by processor 110 or other modules of memory 112.

In some embodiments, memory 112 includes a rule module 114 and a sound analysis module 116. The various modules described herein can be combined in larger modules (e.g., rule module 114 and sound analysis module 116 could be combined into a single module) or separated into smaller modules.

Rule module 114 is configured or programmed to establish one or more sound processing rules that each use at least one target sound as an input. In some embodiments, rule module 114 receives a target sound input identifying one or more target sounds and a rule input to define a sound processing rule.

In some embodiments, the target sound input may indicate a category of sound. Categories of sound may include background noise, a specific voice, a specific audio track (e.g., a vocal track, a music track (e.g., bass track, drum track, guitar track, etc.), a sound effect track, a track associated with a specific frequency range, a track associated with a particular speaker, etc. The category of sound may indicate a type of sound. Types of sound may include a naturally occurring sound (e.g. a voice, an animal sound, a weather sound, etc.). The type of sound may also include a manmade sound (e.g. an alarm, a mechanical noise, instrumental music, etc.). The target sound input may indicate a sound source (e.g., the voice of a specific person, the sound produced by a specific speaker, etc.) The target sound input may indicate a sound location from which sound emanates. The location may be determined relative to user (e.g. to the front, rear, left, right, above, below, etc. of the user) or the location may be absolute (e.g. a compass direction, etc.). The location relative to a user may be relative to the user's real world physical position or orientation or relative to the user's virtual position or orientation in a virtual reality or video game environment (e.g., relative to the position of the user's character's in the virtual environment of the video game). The target sound input may indicate targeted content. Targeted content may include a spoken name or other word, a spoken phrase, a musical phrase or theme, a particular topic of conversation, or other pattern recognizable by a sound processing system (e.g., speech detection system, speech recognition system, speech source location system, etc.). A second target sound input may be identified by the user. The second target sound may be a default target sound (e.g., background noise), may be a threshold (e.g., a volume, a frequency, a tone, a pitch, a duration, etc.), or may be a second sound input similar to those described above (e.g., to establish a rule identifying two specific voices, two specific tracks, etc.).

The rule input defines the relationship(s) among the inputs (e.g., target sound inputs) and the sound processing performed by the sound processing rule. The rule input may receive many user inputs provided via user interface 108 to define the sound processing rule (e.g., to define multiple Boolean logic relationships, to define the various fuzzy operators used for a fuzzy logic comparison performed by the sound processing rule, to define the sound processing to be applied, to define how multiple sound processing rules are prioritized or otherwise related to one another, etc.). The rule input may use logic (e.g., Boolean logic, fuzzy logic, etc.), mathematical rules, algorithmic rules, or other appropriate rules or relationships to define the sound processing rule. A mathematical rule may relate one or more quantifiable properties of the target sound input (e.g., probability of presence of the target sound, amplitude of the target sound, duration of the target sound) to a variable (e.g., gain, bandwidth, apparent position, delay) for processing. The change to variable may be linear or nonlinear (e.g., exponential, logarithmic, etc.). An algorithmic rule may apply one or more logical or mathematical rules to sequences, loops, indexing, etc. of the target sound. For example, the first three times the target sound is identified, process the sound in a particular way (e.g., increase volume, change apparent position, etc.). If the user has does not respond to the first sound processing (e.g., increasing the volume of a superior's orders) within a predetermined time then ignore (e.g., mute) the target sound until a second target sound is identified (e.g., the superior saying the user's name), then repeat the first target sound (e.g., the superior's orders). The rule may compare the target sound to a threshold (e.g. a minimum, a maximum), which may be predetermined or set as a second sound input by the user. The rule may compare a target sound to another sound input (e.g., a second target sound, a default sound, background noise, etc.). For example, the rule may call for the volume of the first target sound (e.g., the voice of a designated speaker) to be increased by a certain amount (e.g., doubled) only when a second target sound (e.g., an alarm) is present. In this way, the user would be better able to hear the voice of the designated speaker even when an alarm is sounding. The rule may identify the target sound and apply the called-for processing for a period of time. The period of time may be predetermined (e.g., apply the sound processing for 30 seconds) or not (e.g., applying the processing until the speaker stops speaking).

The sound processing applied by the sound processing rule may control various audio aspects of the sound input. Audio aspects include volume, equalization spectrum, time delay, pitch, apparent source location, tone, frequency, etc. The sound processing may be applied to one or more sounds in the sound input (e.g., the target sound, sounds other than the target sound, etc.). The sound processing may make no change to the sound input when the results of the rule analysis indicate no sound processing is to be performed.

In some embodiments, the sound processing rule is user defined. In other embodiments the sound processing rule is predefined. Predefined rules may be selected from a list of predefined rules. The predefined rules may include user variable parameters—for example, how much to increase or decrease the volume of the target sound or adjusting the input sensitivity to the target sound (e.g., adjusting a minimum threshold volume that indicates the presence of the target sound).

Sound analysis module 116 is configured to receive a sound input, analyze the sound input for the target sound input(s), process the sound input according to the sound processing rule in view of that analysis and provide a processed sound output. In some embodiments, sound analysis module 116 makes use of cocktail party processing to analyze the sound input for the target sound input(s). Cocktail party processing carries out a sound analysis that emulates the cocktail party effect, which is humans' ability to selectively listen to focus on a specific speaker from among the many voices or other sounds present at a cocktail party or other setting where multiple sounds and are present. Examples of suitable cocktail party processing approaches can be found in Improved Cocktail-Party Processing, Alexis Favrot, Markus Erne, and Christof Faller, Proceedings of the 9^{th} International Conference on Digital Audio Effects (DAFx-06), Montreal Canada, Sep. 18-20, 2006 and in Cocktail Party Processing via Structured Prediction, Yuxuan Wang and DeLiang Wang, The Ohio State University, which are incorporated by reference herein. In some embodiments, sound analysis module 116 uses speech detection, speech recognition, or speech source localization techniques to analyze the sound input for the target sound input(s). Suitable techniques can be found in Smart Headphones: Enhancing Auditory Awareness Through Robust Speech Detection and Source Localization, Sumit Basu, Brian Clarkson, and Alex Pentland, Proceedings of the International Conference on Acoustics, Speech, and Signal Processing, Salt Lake City, Utah, May, 2001, which is incorporated by reference herein.

In some embodiments, sound analysis module 116 receives a video input (e.g. from camera 107) and makes use of the video input to analyze the sound input for the target sound input(s). Examples of suitable processing approaches include for identifying specific sounds based on a video input can be found in Audio-Visual Segmentation and “The Cocktail Party Effect”, Trevor Darrell, John W. Fisher III, Paul Viola, and William Freeman, which is incorporated by reference herein. Facial recognition programming may also be used to determine when a designated person or location is producing the target sound (e.g., determine when a designated person is speaking).

In some embodiments, sound analysis module 116 makes use of specific tracks, inputs, metadata, or other identifying characteristics to analyze the sound input for the target sound input(s).

In some embodiments, sound analysis module 116 is configured to receive one or more additional inputs to identify one or more traits of the sound input. In some embodiments, the additional inputs may be in the form of metadata associated with various traits of the sound input. The traits may indicate a particular sound source (e.g., a sound received by a particular microphone, a particular voice), a particular topic of conversation, a particular audio track (e.g., a vocal track, a music track (e.g., bass track, drum track, guitar track, etc.), a sound effect track, a track associated with a specific frequency range, a track associated with a particular speaker, etc.) or a particular user (e.g., a particular user in a multi-player video game, a particular user in a telephone or video conference, etc.). For example, when the sound input is provided by a media device the media being played by the media device could include multiple tracks each with an input identifying the trait of the specific track (e.g., with a metadata identifier). For example, in a video game setting, the input could indicate different team members, different types of sounds, different topics of conversation, different spoken languages, different directions of sound, etc. This would allow the user to identify and focus known friendly team members, known enemy team members, or identify unknown speakers. For example, speakers of a first language may be identified as friendly and speakers of a second language may be identified as enemies. As another example, in a video game setting, a user on an espionage mission may need to eavesdrop on various conversations to identify a particular plan. The analysis module 116 could identify words spoken by a specific speaker or group of speakers (e.g., the enemy boss and the enemies, in general), identify specific keywords (e.g., plan, mission, objective, etc.), identify specific topics of conversation (e.g., troop movements, mission assignments, etc.), or identify the specific speaker or group of speakers based (e.g., the enemy boss and the enemies, in general) based on specific words or topics of conversation. In some embodiments, the trait indicates a sound location from which the target sound emanates. This location may be measured relative to the user. In some embodiments, the location may be identified using compass directions (e.g., north, south, east, west, etc.) or the user's frame of reference (i.e. front, back, left, right, up, down, etc.). In other embodiments, the location is the known location of a speaker or microphone.

In some embodiments, memory 112 includes a sample module 118 that is configured or programmed to provide a sample output of the processed sound output. In some embodiments, the sample output is a sound output of a portion of the processed sound output that allows the user to preview of the processed sound output. In some embodiments, the sample output may be a graphical representation of the processed sound output (e.g. shown as a sine wave). For example, the sample output may be used to test or calibrate sound processing controller 102.

The amount of time used by the sound processing controller 102 to carry out the processing (i.e., analyzing the sound input, processing the sound input according to the appropriate rule(s), and providing a processed sound output) can vary in different embodiments. In a first embodiment, the sound processing controller 102 carries out the processing substantially in real time with a negligible delay between receiving the sound input and providing the processed sound output where the negligible delay is less than 100 milliseconds (e.g., 1 millisecond, 10 milliseconds, etc.). This embodiment is appropriate when using a relatively fast controller or when applying a processing scheme with relatively low processing demands. In a second embodiment, the sound processing controller 102 carries out the processing with a fixed delay between receiving the sound input and providing the processed sound output (e.g., 0.5 seconds, 1 second, 5 seconds, etc.). This embodiment is appropriate when using a relatively slow controller, when applying a relatively complex processing scheme (e.g., multiple processing rules), or when the delay is only apparent to the user when the processing is first activated. For example, a user may use the controller 102 to apply a complex processing scheme to a movie or other prerecorded audio-visual programming. After the initial delay to allow for the audio processing, the user is able to watch the movie visuals in synchronization with the processed sound output. This may allow for the use of a lower cost controller in a media device. In a third embodiment, the sound processing controller 102 carries out the processing with a variable delay between receiving the sound input and providing the processed sound output and an accompanying pause in the processed sound output (i.e., the processed sound output pauses when needed to allow time for the processing to be completed). This embodiment is appropriate when a pause in audio playback is acceptable to the user (e.g., when the user is reviewing the results of a particular sound processing rule or rules). In a fourth embodiment, the sound processing controller 102 carries out all of the processing to be applied to an audio file or an audio-visual file on a batch basis before providing the processed sound output. This embodiment is appropriate when the user is able to wait to hear the processed sound output (e.g., when applying sound processing rules to an entire song or movie). Also, files can be processed and saved after processing for later use.

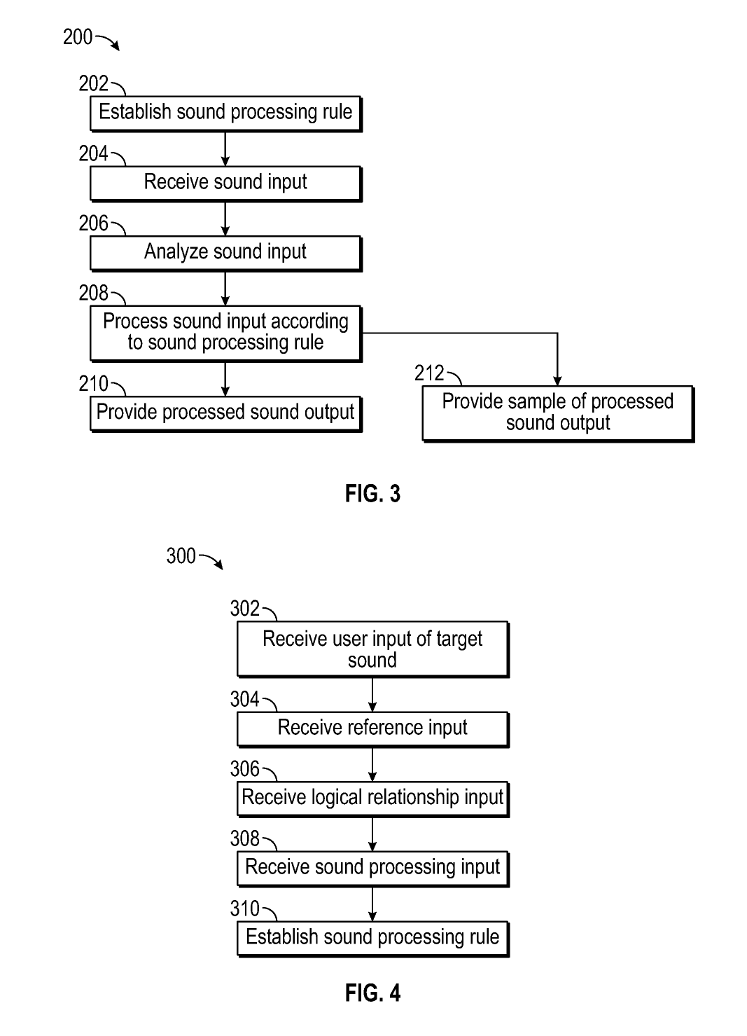

Referring to FIG. 3, a flowchart of a process 200 for rule-based user control of audio rendering is shown, according to an exemplary embodiment. Process 200 includes the steps of establishing a sound processing rule (step 202), receiving a sound input (step 204), analyzing the sound input (step 206), processing the sound input according to the sound processing rule (step 208), and providing a processed sound output (step 210). In some embodiments, process 200 may also include the step of providing a sample of the processed sound output (step 212). Establishing the sound processing rule (step 202) may be performed by sound processing controller 102 as described herein. Receiving the sound input (step 204) may be performed by sound processing controller 102 as described herein. For example, sound processing controller 102 may receive the sound input from one or more microphones 104 or from one or more media devices. Analyzing the sound input (step 206) may be performed by sound processing controller 102 as described herein. Processing the sound input according to the sound processing rule (step 208) may be performed by sound processing controller 102 as described herein. Providing the processed sound output (step 210) may be performed by sound processing controller 102 as described herein. Proving the sample of the processed sound output may be performed by sound processing controller 102 as described herein.

Referring to FIG. 4 a flowchart of a process 300 for establishing a sound processing rule is shown, according to an exemplary embodiment. Process 300 includes the steps of receiving a user input of a target sound (step 302), optionally receiving a second target sound (e.g., a reference input that the first target sound is compared to or evaluated against) (step 304), receiving a rule input (step 306), and receiving a sound processing input indicating the sound processing to be performed (step 308) to establish a sound processing rule (step 310) in which the target sound(s) are evaluated according to the rule and the sound processing will be performed in response to that evaluation. The user input of the target sound (step 302) may be received by sound processing controller 102 as described herein. For example, the target sound may be selected from a list of possible target sounds, indicated based on a trait (e.g., as indicated by metadata), indicated based on a video input (e.g., identifying a particular speaker), indicated based on a sound input (e.g., from a particular microphone or audio input), indicated by identifying a sound source (e.g., a particular speaker, a particular track, etc.), indicated by identifying a particular category of sound, indicated by identifying a direction from which the sound emanates, or indicated by identifying targeted content (e.g. a particular name, word, phrase, topic of conversations, etc.). The second target sound input (step 304) may be received by sound processing controller 102 as described herein. For example, the second target sound input may be selected by the user similar to the selection of the first target sound. Alternatively, the second target sound input may be a default (e.g., a particular threshold) to which the target sound is compared. In some embodiments, the default includes a variable parameter (e.g., to adjust the threshold value). The rule input (step 306) may be received by sound processing controller 102 as described herein. For example, the rule input may be selected by the user similar to the selection of the target sound. Alternatively, the rule input may be a default (e.g., greater than, less than, equal to, etc.) for comparing the target sound to another sound or threshold (e.g., as entered as the second target sound). The sound processing input (step 308) may be received by sound processing controller 102 as described herein. For example, the sound processing input may be selected by the user similar to the selection of the target sound. Alternatively, the sound processing input may be a default (e.g., increase volume, decrease volume, do nothing, etc.) to applied based on the result of the rule analysis of the target sound. In some embodiments, the default includes a variable parameter (e.g., to control the amount of volume increase, to control the amount of volume decrease, etc.).

Rule-based user control of audio rendering as described herein may be implemented in many virtual and real world applications. Virtual applications may include video games, movies, or television programs in which a soundtrack is manipulated according to the rule-based user control of audio rendering. Real world applications include communication equipment (e.g., telephone and video conferencing equipment), headphones, speakers, or other equipment in which real-time sounds (i.e., sounds not recorded or part of soundtrack) are manipulated according to the rule-based user control of audio rendering. Combined applications include applications where both a soundtrack and real-time sounds are manipulated according to the rule-based user control of audio rendering.

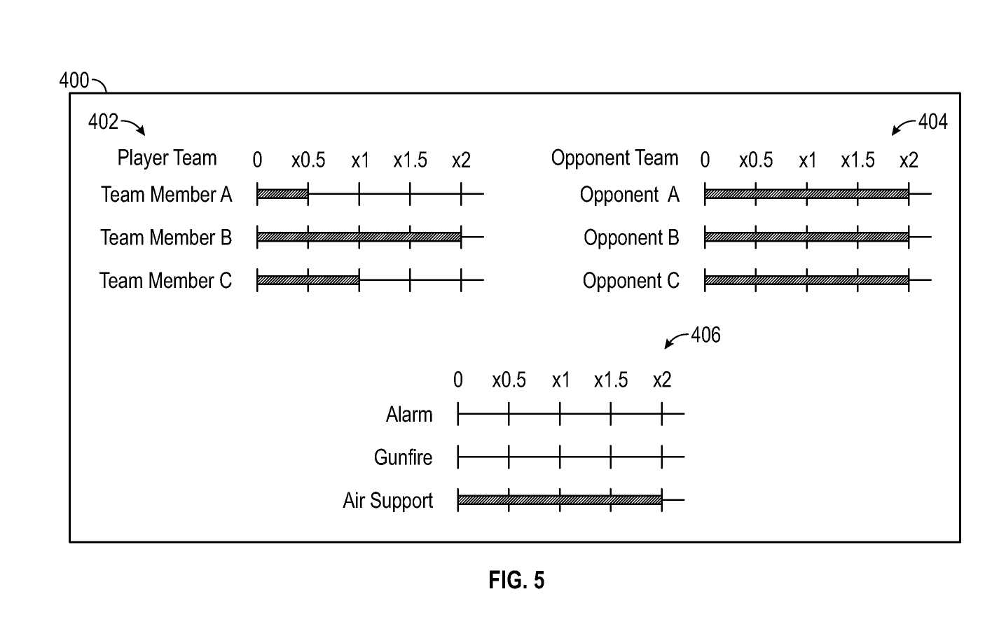

Rule-based user control of audio rendering as described herein allows the user to modify the sound track for virtual applications according to the user's selected sound processing rules. For example, when playing a first person shooter or other action type video game the user may be part of a team with each team member having different tasks. Accordingly, the user may want to focus on particular sounds to better accomplish his tasks. As shown in FIG. 5, which illustrates a graphical user interface 400 according to an exemplary embodiment, the user can control the volume level of team members 402 including team members A, B and C as well as control the volume level for opponents 404 including opponents A, B and C. In addition, the user can control the volume of specific background sounds 406 including the sound of an alarm, the sound of gun fire or the sound of air support approaching. Adjusting the slider (variable parameter) of the volume for each of these target sounds increases or decreases the volume of the target sound from its original volume. Each slider is the visual representation of a sound processing rule. Establishing each sound processing rule by adjusting the slider allows the user to perform tasks such as focusing on his leader (e.g. team member B) by increasing volume, focusing on listening for members of the opponent team by increasing volume, focusing on listening for one or more background sounds by increasing and/or by decreasing the volume on other sounds not related to the user's task. The ability to implement rule-based control on the sound input may allow the user to more effectively achieve his tasks. As illustrated in FIG. 5, the user is deemphasizing team member A, focusing on team member B, treating team member C neutrally, focusing on all three opponents, focusing on air support, and ignoring alarms and gunfire.

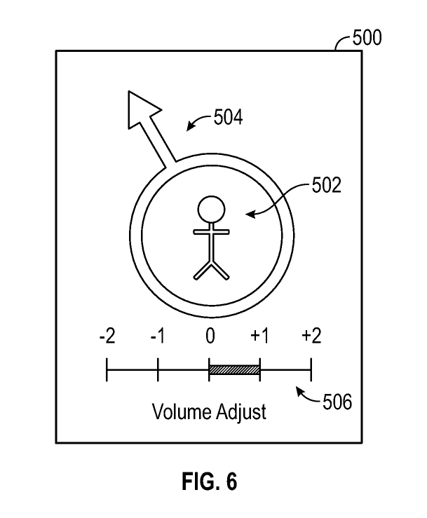

As another example, a user may wish to focus on sounds coming from a particular direction. This may be applicable to both virtual and real world applications. As shown in FIG. 6, which illustrates a graphical user interface 500 according to an exemplary embodiment, the user can control the volume level of target sounds emanating from a particular direction. The user interface 500 includes an indicia of the user 502, an arrow 504 used to indicate the particular direction of the target sounds, and a slider to adjust the amount of volume increase or decrease of the target sounds. The direction of the target sounds may be absolute (e.g., compass directions) or relative to the direction in which the user is facing. For example, a user listening to music on headphones while waiting in an airport terminal may wish to target sounds emanating from a departure gate, thereby allowing the user to hear any boarding announcements while still enjoying music during his wait.

As another example, a user may wish to detect specific targeted content like the name of the user's character or a particular topic of conversation in a virtual application. For example, the sound processing rule is established to detect the user's character's name and the sound input is sampled and analyzed using speech detection and speech recognition techniques to identify when the user's character's name is spoken. When the user's character's name is detected, the sound input is processed according to the sound processing rule (e.g., by increasing the volume of the voice speaking the name, reducing the volume of sounds other than the voice speaking the name, etc.). As another example, the sound processing rule is established to detect a particular topic of conversation like mission plans, troop movements, troop numbers, etc. In this way, the user is able to spy or eavesdrop on the conversations of other characters in a virtual application. With these approaches, the sound processing rule is established to identify particular targeted content (e.g., a name, word, phrase, topic of conversation, etc.), rather than a particular source of sound (e.g., a specific speaker, a specific direction, a specific audio track, a specific musical instrument, etc.).

As another example, rule-based user control of audio rendering may reduce background noise or eliminate multiple people speaking over one another on an audio or video conference. For example, in an audio conference where a designated person is presenting in a conference room that includes other people. One or more sound processing rules could be established to focus in the direction of the designated person as the target sound, establish the sound of the designated person's voice as the target sound, identify the designated person via a video input, etc. with other background sounds including sounds from other people in the room with the designated person and background noise such as moving chairs, people eating, etc. reduced. This enables participants in the conference to focus on the designated person and not on other speakers and unwanted background noise. In another example, a set of sound processing rules could be established to prioritize the order in which remote participants are heard on the conference. For example, the voice of the Chief Executive Officer could be prioritized over the voice of other participants on the conference.

As another example, rule-based user control of audio rendering is used with a media device (e.g., a smartphone or other mobile device) configured for use as a virtual tour guide at a museum, historical site, or other place of interest. The user may establish the sound processing rules so that the tour guide audio being played on the media device is preferred over background sounds except for sounds such as an alarm or the user's selected companion. For example, this would enable a family to play a tour guide audio track each on their smartphones with headphones on but hear a fire alarm in the case of emergency and allow the parents to pay attention to questions of the children as needed.

While various aspects and embodiments have been disclosed herein, other aspects and embodiments will be apparent to those skilled in the art. The various aspects and embodiments disclosed herein are for purposes of illustration and are not intended to be limiting.

1. A sound processing controller, comprising:
processing electronics comprising a processor and a memory, wherein the processing electronics is configured to:
receive a target sound input identifying a target sound;
receive a rule input establishing a sound processing rule that references the target sound;
receive a sound input;
analyze the sound input for the target sound;
process the sound input according to the sound processing rule in view of the analysis of the sound input; and
provide a processed sound output.

2-13. (canceled)

14. The sound processing controller of claim 1, wherein the target sound comprises a sound location.

15. The sound processing controller of claim 14, wherein the sound location is relative to a user's physical position or orientation.

16. The sound processing controller of claim 14, wherein the sound location is relative to a user's virtual position or orientation.

17. The sound processing controller of claim 14, wherein the sound location is absolute.

18-20. (canceled)

21. The sound processing controller of claim 1, wherein the sound input is processed to control an audio aspect of the sound input according to the sound processing rule.

22-28. (canceled)

29. The sound processing controller of claim 1, wherein the sound processing rule establishes a rule referencing the target sound.

30. The sound processing controller of claim 29, wherein the rule compares the target sound to a threshold.

31. The sound processing controller of claim 29, wherein the rule compares the target sound to another sound.

32. The sound processing controller of claim 29, wherein the rule is a logical rule.

33. The sound processing controller of claim 32, wherein the logical rule is expressed in Boolean logic.

34. The sound processing controller of claim 32, wherein the logical rule is expressed in fuzzy logic.

35. The sound processing controller of claim 29, wherein the rule is a mathematical rule.

36. The sound processing controller of claim 29, wherein the rule is an algorithmic rule.

37-65. (canceled)

66. The sound processing controller of claim 1, wherein the target sound comprises targeted content.

67. The sound processing controller of claim 66, wherein the targeted content comprises a name.

68. The sound processing controller of claim 66, wherein the targeted content comprises a word.

69. The sound processing controller of claim 66, wherein the targeted content comprises a phrase.

70. The sound processing controller of claim 66, wherein the targeted content comprises a topic of conversation.

71. The sound processing controller of claim 66, wherein analyzing the sound input for the target sound includes sampling the sound input for the targeted content.

72. The sound processing controller of claim 1, wherein the target sound comprises targeted content from a virtual application.

73-77. (canceled)

78. The sound processing controller of claim 1, wherein the target sound comprises targeted content from a real world application.

79-83. (canceled)

84. The sound processing controller of claim 1, wherein the processing electronics is further configured to:
receive the sound input, analyze the sound input, process the sound input, and provide the processed sound output with a negligible delay between receiving the sound input and providing the processed sound output.

85-87. (canceled)

88. The sound processing controller of claim 1, wherein the processing electronics is further configured to:
receive the sound input, analyze the sound input, process the sound input, and provide the processed sound output with a fixed delay between receiving the sound input and providing the processed sound output.

89-91. (canceled)

92. The sound processing controller of claim 1, wherein the processing electronics is further configured to:
receive the sound input, analyze the sound input, process the sound input, and provide the processed sound output with a variable delay between receiving the sound input and providing the processed sound output.

93. A sound processing system, comprising:
a sound input device for providing a sound input;
a sound output device for providing a sound output; and
processing electronics comprising a processor and a memory, wherein the processing electronics is configured to:
receive a target sound input identifying a target sound;
receive a rule input establishing a sound processing rule that references the target sound;
receive a sound input from the sound input device;
analyze the sound input for the target sound;
process the sound input according to the sound processing rule in view of the analysis of the sound input; and
provide a processed sound output to the sound output device.

94-117. (canceled)

118. The sound processing system of claim 93, wherein the target sound comprises a sound source.

121-127. (canceled)

128. The sound processing system of claim 93, wherein the sound input is processed to control an audio aspect of the sound input according to the sound processing rule.

129-135. (canceled)

136. The sound processing system of claim 93, wherein the sound processing rule establishes a rule referencing the target sound.

137-172. (canceled)

173. The sound processing system of claim 93, wherein the processing electronics is further configured to:
receive the sound input, analyze the sound input, process the sound input, and provide the processed sound output with a negligible delay between receiving the sound input and providing the processed sound output.

174-176. (canceled)

177. The sound processing system of claim 93, wherein the processing electronics is further configured to:
receive the sound input, analyze the sound input, process the sound input, and provide the processed sound output with a fixed delay between receiving the sound input and providing the processed sound output.

178-180. (canceled)

181. The sound processing system of claim 93, wherein the processing electronics is further configured to:
receive the sound input, analyze the sound input, process the sound input, and provide the processed sound output with a variable delay between receiving the sound input and providing the processed sound output.

182. A media device, comprising:
processing electronics comprising a processor and a memory, wherein the processing electronics is configured to:
receive a target sound input identifying a target sound;
receive a rule input establishing a sound processing rule that references the target sound;
receive a sound input from the sound input device;
analyze the sound input for the target sound;
process the sound input according to the sound processing rule in view of the analysis of the sound input; and
provide a processed sound output to the sound output device.

183-203. (canceled)

204. The media device of claim 182, wherein the target sound comprises a sound location.

205-255. (canceled)

256. The media device of claim 182, wherein the processing electronics is further configured to:
receive the sound input, analyze the sound input, process the sound input, and provide the processed sound output with a negligible delay between receiving the sound input and providing the processed sound output.

257-299. (canceled)
